(19) United States
(12) Patent Application Publication
(10) Pub. No.: US 2024/0388323 A1
(43) Pub. Date: Nov. 21, 2024

(54) Dual Channel Devices

(71) Applicant: Contrast, Inc., Albuquerque, NM (US)

(72) Inventors: Willie Chris Kiser, Albuquerque, NM (US); Nora Tocci, Albuquerque, NM (US); Jason Hoy, Albuquerque, NM (US); Mike Tocci, Albuquerque, NM (US)

(21) Appl. No.: 18/609,257

(22) Filed: Mar. 19, 2024

Related U.S. Application Data
(60) Provisional application No. 63/507,487, filed on Jun. 12, 2023.
(60) Provisional application No. 63/502,184, filed on May 15, 2023.

(51) Int. Cl. H04B 5/72

(52) U.S. Cl. CPC H04B 5/72

(57) ABSTRACT

The invention provides methods and devices for communication and tracking of multiple devices.

### FIELD OF THE INVENTION

The invention relates to methods and devices for radio frequency communication and power modulation.

### BACKGROUND OF THE INVENTION

Radio frequency is useful for short-range communications. For example, radio frequency identification (RFID) technologies use certain electromagnetic fields to identify, track, and register electronic devices. In a common instance, an RFID system includes a transmitter or transponder that sends digital data to a reader in response to an electromagnetic interrogation signal. Conventional RFID systems are an improvement in near-field communication that is useful to capture data, trigger a response (e.g., the opening of a door), register information, and identify individuals, all with reduced risk of data theft.

RFID systems have been used to great effect to track inventory during production and manufacturing, and sales, register point-of-sale transactions, and to identify people and goods. In general, an RFID tag contain an integrated circuit that receives radio frequency signals and stores and/or processes information. There is typically an antenna that is used to receive the signal. The tags can be passive or active. Generally, active tags require a power source, such as a battery. An RFID system generally also comprises a reader, which can also be passive or active. The combination of the tag and the reader, set to a predetermined frequency, provides a low-cost means for short-range communication. The systems generally are useful for access management, tracking of goods or people, contactless transactions, and other uses consistent with the need for short-range communication.

While RFID systems are widely used, such systems have limitations. For example, a system that is always on must be powered and batteries often need to be changed or recharged. In addition, conventional RFID systems are not modular in that the user cannot turn the broadcasting signal/receiver on and off based either on location or activity.

### SUMMARY OF THE INVENTION

The invention comprises radio frequency systems and their use in which a first device communicates with a second device over a first frequency and in which a separate transmitter frequency is used to turn the first device on and off; and alternatively, or in addition, track the first device. In a preferred embodiment, the second frequency is broadcast in a confined area such that when a user of the device is present in the area, the device is activated (turned on). Once activated, the first device then is able to communicate via the first frequency with the second device.

In a preferred embodiment of the invention, a first device comprises a chip that transmits a radio frequency signal on a first frequency to a second device that receives the signal. The first device also contains a receiver that receives a signal from a remote transmitter 105 that switches on a power supply in the first device when the first device is in a vicinity of a transmitting signal from the remote transmitter 105. In this way, the first device is operational only when in the vicinity of the transmitting signal that activates it. In a preferred embodiment, the receiver in the first device is an AM receiver that, when activated, generates a voltage that turns on a power supply in the first device. While in the vicinity of the transmitting signal, the first device is operational to interact with the second device.

Thus, the invention relates to a device that broadcasts and receives a dual signal, one to communicate with a second device and one that receives a signal that activates the device, but only when the device is in proximity to the source of the activation signal. For purposes of the invention, the “vicinity” of the transmitting and receiving devices is determined by the user, constrained only by the frequencies used. For example, the “vicinity” of the devices may be between about 10 and about 100 feet.

In an alternative embodiment, the second device is used to track the first device's location. This can be done independently of turning the first device on/off. In this embodiment, the invention comprises a method for tracking multiple targets simultaneously. Preferably, the first device comprises a unique identifier that is tracked in real time with the motion of the first device. In this embodiment, the second device is a tracking device and the first device is a target. Accordingly, the tracker (second device) tracks multiple targets (first device) simultaneously. In this way, the second device not only activates the first device but can track its location and distinguish it from other targets (first device) even in close proximity.

Further features and advantages of the invention are apparent upon consideration of the following detailed description thereof.

### BRIEF DESCRIPTION OF THE DRAWINGS

FIG. 1 shows an exemplary circuit diagram according to the invention.

FIG. 2 shows an instance of the invention.

FIG. 3 shows a mode of operation of a system of the invention.

FIG. 4 shows an example of subsystems used in tracking.

FIG. 5 shows an exemplary use for tracking multiple targets.

FIG. 6 shows an example of subsystems without the need for an external tracking system.

FIG. 7 an exemplary use for tracking multiple targets without the need for an external tracking system.

FIG. 8 shows an example of subsystems without the need for an external tracking system.

FIG. 9 an exemplary use for tracking multiple targets without the need for an external tracking system.

### DETAILED DESCRIPTION OF THE INVENTION

The present invention comprises a system in which a first device is in radio frequency (RF) communication with a second device, the first device being activated or turned on by a transmitter that broadcasts at a frequency that is different from the communication frequency between the first and second devices. The first device is activated only when in proximity to or in the vicinity of the transmitter; otherwise it remains off.

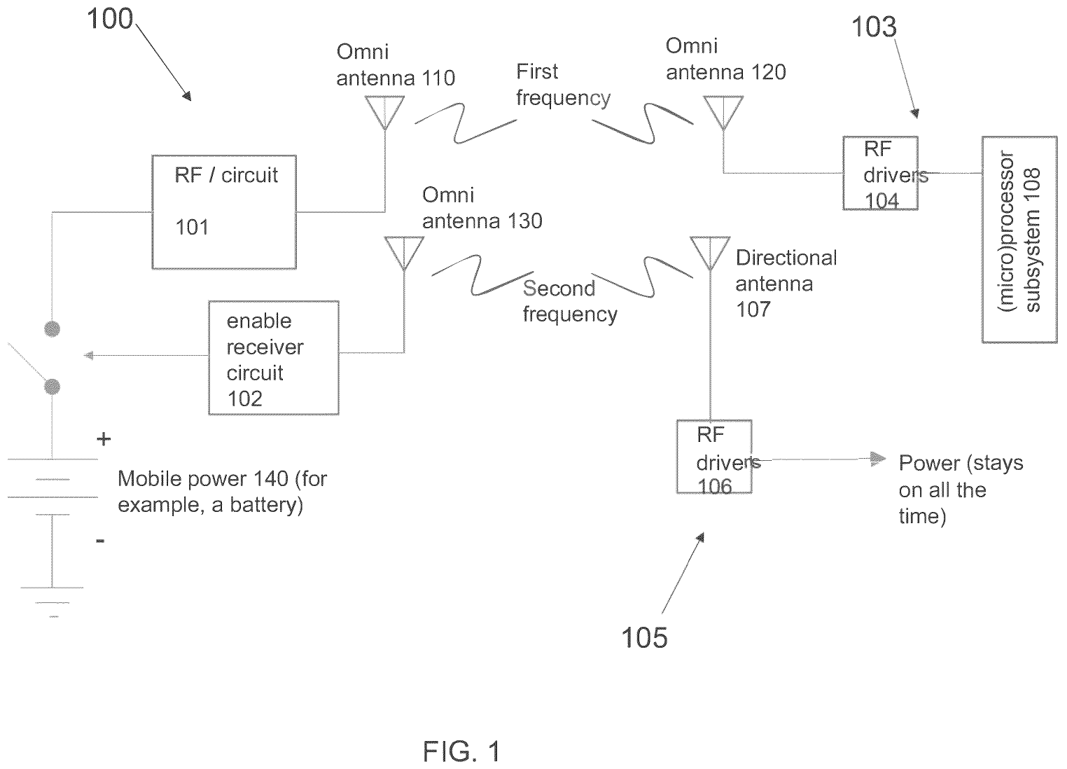

The invention provides a system for effecting automatic, remote wireless power-on and power off combined with remote, wireless communication. FIG. 1 shows an exemplary circuit diagram for a system of the invention. As shown in FIG. 1, a first device, 100, having an RF circuit 101, a receiver circuit 102 (preferably an AM receiver circuit as shown), and a mobile power supply 140 (for example a battery as shown). The system also includes a second device, 103, that interacts with the first device 100 at a first frequency (which, for example, could preferably be 915 MHz). Finally, a transmitter, 105, broadcasts a signal at a second frequency (which, for example, could preferably be 868 MHZ) that interacts with the first device 100 when the first device 100 and the transmitter 105 are in proximity to one another. The transmitter 105 is shown in the Fig. as comprising a radio frequency (RF) driver 106 connected to a directional transmit-only antenna 107. The second device 103 may also have a radio frequency (RF) driver, 104, connected to an antenna 120, which is preferably omni (non-directional), to enable communications. The second device may also comprise various microcircuitry 108 as needed to effect the purpose of communication between the first device 100 and the second device 103. The first device 100 comprises an enable receiver circuit 102, which comprises a capacitor (not shown in the Fig.), connected to an antenna 130, which is preferably omni (non-directional), to enable communications. The enable receiver circuit 102 provides a power-on enable signal when it receives the proper amount of RF power at a second frequency, which could preferably be, for example, 868 MHz. When this power-on enable RF signal is received by the enable receiver circuit 102, the entire first device 100 receives power from the mobile power source 140 (which could for example be a battery). And then, as soon as the amount of RF power received by this enable receiver circuit 102 and antenna 130 drops below that proper amount, the circuit 102 automatically provides a power-off enable signal, thereby automatically turning off the entire first device 100. The mobile power source 140 shown in the Figure may be a battery or it may alternatively be an induction coil, which can receive power wirelessly through the phenomenon of magnetic resonance coupling, provided a matched-frequency induction coil is located nearby the mobile component. In this way, the first device 100 can be made to work without any attached battery.

The frequency ranges and/or transmission protocols used are subject to national or supranational regulations that are issued by the responsible legislator and that are frequently based on standards or standardizations that are developed by international organizations such as the IEEE (Institute of Electrical and Electronics Engineers). Specific frequency ranges, which are also designated as ISM bands (industrial, scientific and medical bands), are usually provided for an approval-free operation of radio frequency devices in industry, science, medicine and the domestic sector. The different frequency ranges are frequently designated by a respective characteristic frequency. Examples of this are the frequency ranges around the frequencies 315 MHz, 433 MHZ, 868 MHz, 915 MHz of the 2.4 GHz frequency.

In accordance with various embodiments, the devices may contain internal batteries, and the device may or may not be operating during receipt of power. Depending on the degree of charge status of the battery or its presence and the system design, the applied power can provide power to the device, charge its battery or a combination of the above. The terms charging and/or power are sometimes used interchangeably herein to indicate that the received power can be used for either of these cases or a combination thereof.

The present invention may provide an AM receiver circuit which performs sound quality compensation of an AM detection output signal. The AM receiver circuit comprises an intermediate frequency signal section which amplifies and outputs an intermediate frequency signal generated from a received broadcast wave, an AM detection section which detects and outputs an AM modulation signal from the intermediate frequency signal output, a band-pass filter for extracting a carrier wave frequency component from the intermediate frequency signal output, an integrator for integrating the output from the band-pass filter so as to convert the carrier wave intensity of the intermediate frequency signal output into a direct current voltage for output, and a sound quality compensation section which compensates sound quality of an output signal from the AM detection section in accordance with the direct current voltage output from the integrator. With this arrangement, field intensity of the received broadcast wave can be determined even when the field intensity is low, such that appropriate sound quality compensation can be performed in accordance with low field intensity levels.

The first device, 100, may include circuitry 101 to provide communications and also other effects such as LEDs that turn on, turn off, change color, etc. It can also include haptics, such as a vibration device or a sound emitter. In one embodiment, the first device 100 may contain two omni antennas 110 and 130, the enable receiver circuit 102, the RF/circuit 101, and any effects such as LEDs and haptics.

The second device, 103, may include a computer processor 108, which itself may comprise communications circuitry, to make decisions and tell the first device 100 what to do. In one embodiment, the (micro) processor subsystem 108 is a computer, which is basically the brains of the entire system. It can communicate wirelessly with the first device 100, and it can decide whether and how to turn on any effects (LEDs and haptics, for example) in the first device 100. The second device, 103, can also be connected via cable such as ethernet (not shown in the figures), or it can be connected wirelessly, to communicate to other devices and/or computers on a network.

The radio frequency circuit may be configured to receive and transmit a radio frequency (RF) signal, which is also referred to as an electromagnetic signal. The radio frequency circuit communicates with a communication network and other communication devices via the electromagnetic signal. The radio frequency circuit converts the electrical signal into the electromagnetic signal for transmission, or converts the received electromagnetic signal into the electrical signal. Optionally, the radio frequency circuit includes an antenna system, an RF transceiver, one or more amplifiers, a tuner, an oscillator, a digital signal processor, a codec chipset, a subscriber identity module card, and the like. The radio frequency circuit can communicate with other terminals via at least one wireless communication protocol. The wireless communication protocol includes, but not limited to, a metropolitan area network (MAN), various generations of mobile communication networks (2G, 3G, 4G, and 5G), a wireless local area network (LAN), and/or a wireless fidelity (Wi-Fi) network. In some embodiments, the RF circuit may also include near-field communication (NFC) related circuits, which is not limited in the present disclosure.

In a certain embodiment, an antenna having sending and receiving functions and the radio frequency circuit may be considered as a receiving unit and a sending unit (which may also be collectively referred to as a transceiver unit) of the device, and a processor having a processing function may be considered as a processing unit of the device. The device may include a receiving module, a processing module, and a sending module. The receiving module may also be referred to as a receiver, a receiver circuit, or the like. The sending module may also be referred to as a transmitter, a transmitter circuit, or the like. The processing module may also be referred to as a processor, a processing board, a processing apparatus, or the like.

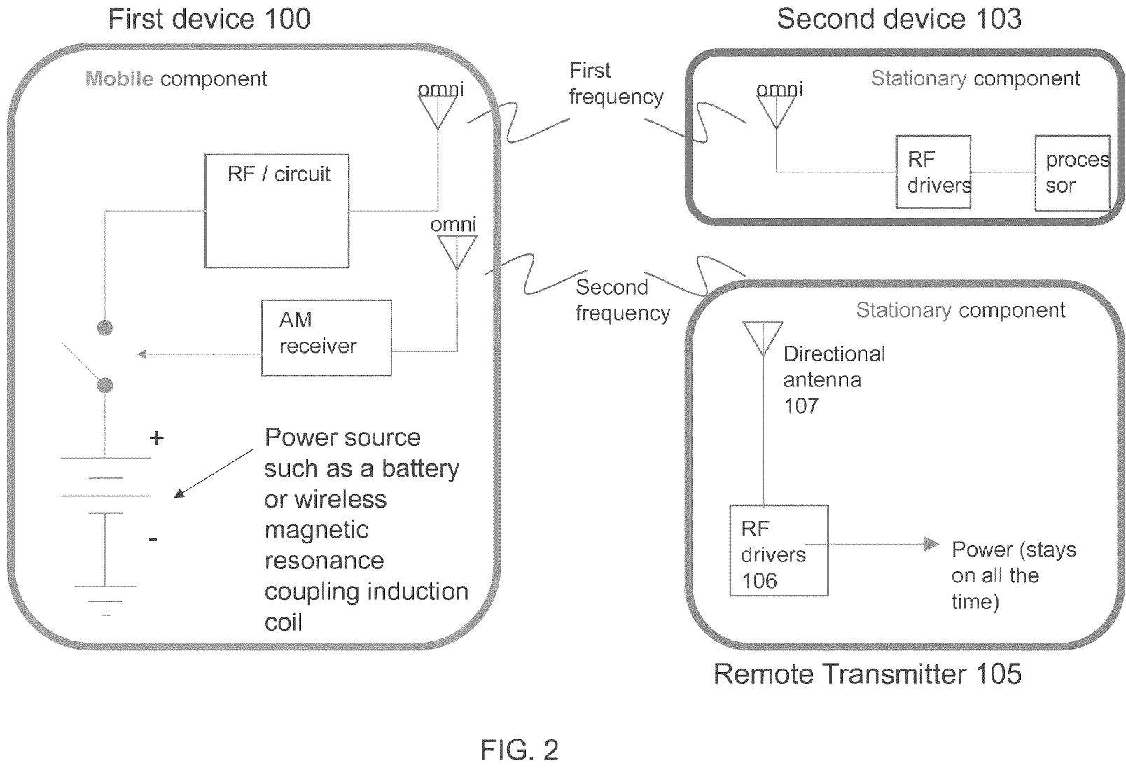

FIG. 2 shows an instance of the invention in which the first device 100 is mobile and the second device 103 and the transmitter 105 are stationary. Thus, when the antenna 130 of the first device, 100, comes into proximity to the transmitter 105, the first device 100 receives the “always on” signal from the transmitter 105, which then activates the enable receiver circuit 102 in the first device, 100, rendering it operational. Then the first device 100 can begin to communicate with the second device 103.

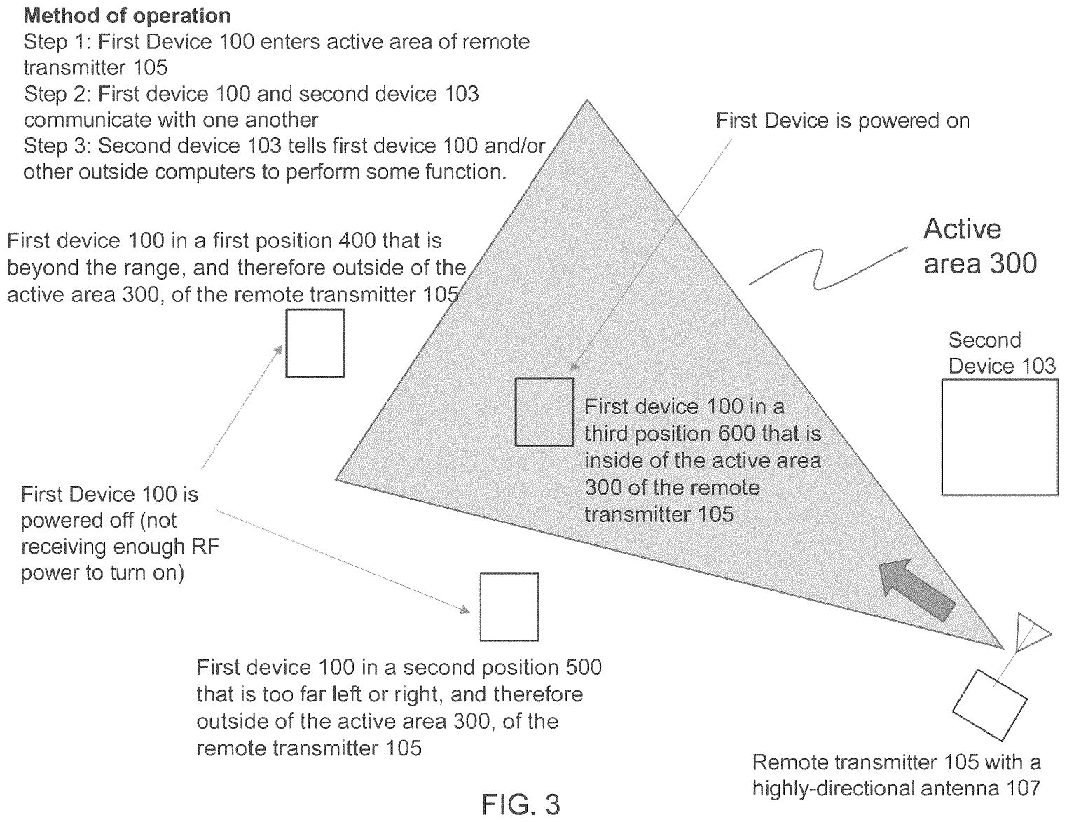

FIG. 3 shows a first step of an exemplary mode of operation of a system of the invention. In that Figure, the first device, 100, begins in a first position 400 that is beyond the range of the active area 300 cone of, and therefore not in proximity to, the transmitter, 105, and therefore the first device 100 is not powered on. The first device 100 alternatively and/or sequentially may be in a second position 500 that is wide of the transmitter's 105 active area 300 cone, and therefore again not in proximity to the transmitter 105. However, when the first device 100 is in a third position 600 that is within the active area 300, and therefore in proximity to the transmitter 105, the first device 100 is powered on. In FIG. 3, the second device, 103, takes the form of a computer having onboard circuitry to enable radio frequency (RF) communication with the first device 100. When active, the first device, 100, interacts with the second device, 103, here comprising a computer, to manipulate a function (such as lights, sounds, haptics, wireless communications, or any other possible function) of the first device 100.

Thus, in one embodiment, a system of the invention comprises a stationary component and a mobile component. Stationary component comprises a stationary “communication” transmit/receive station and a stationary “turn-on” antenna station. The stationary “turn-on” antenna station uses a directional antenna to provide a cone of influence, inside of which the mobile component will automatically turn on, and outside of which the mobile component will automatically turn off.

Due to the physics involved, which includes charging a capacitor in the mobile component at a fast enough speed, the transmitter 105 and its antenna 107 will require significantly more transmit power than the second device's 103 “communication” antenna 120. Because of this, the active area 300 (which preferably has the shape of a cone) can be shortened or lengthened by adjusting the output power of the stationary “turn-on” antenna 107. The angle of cone of the active area 300 can be widened or narrowed by changing the physical geometry of the stationary directional antenna 107. The mobile “turn-on” antenna 130 requires no power at all from the battery 140 (it receives all its power, which is used solely to provide a power-on enable signal inside the first device 100, from the RF stationary “turn-on” wireless signal). Systems of the invention use lower transmit power in the second device 103 for communications. The first device 100 uses less power than conventional RFID systems because it turns on only when necessary, its communications antenna 110 is omni-directional, its antenna 130 for receiving the “turn on signal” is omni-directional, and the entire system works with much lower latency than conventional RFID systems.

In a preferred system, the first device 100 and second device 103 communicate at a frequency of 915 MHZ, a well-established frequency for communication that works at longer ranges than conventional RFID. The “turn on” signal may preferably be set at 868 MHz, which is outside the bandwidth of the communications signal. However, the user can tune the frequencies as desired for operational purposes.

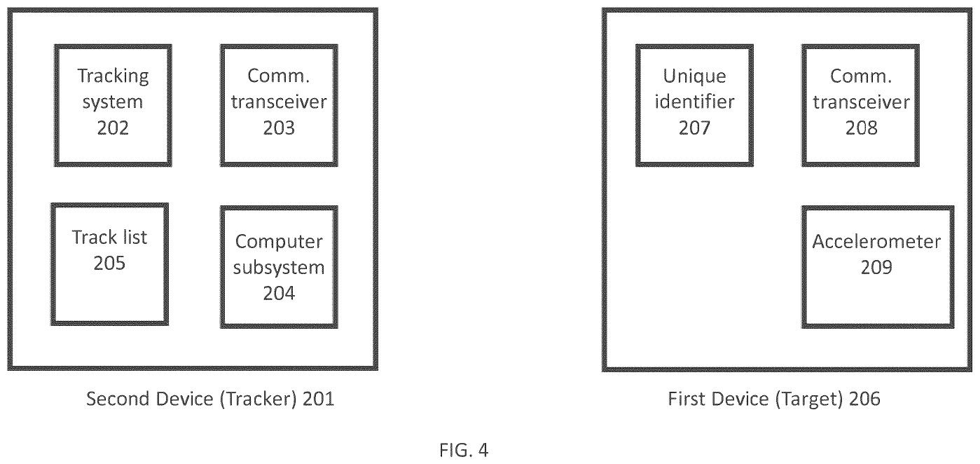

FIG. 4 shows a second device 201 comprising a tracking system 202 and communications receiver (transceiver) 203. The second device may optionally comprise a computer subsystem 204 for execute commands driving tracking and a list 205 of target or first devices being tracked. The first device or target 206 comprises a unique identifier 207, a receiver 208, and optionally an accelerometer 209 (which may be a single-axis, dual-axis, or three-axis accelerometer).

Computer subsystem may include a computer, display, and speaker. Computer includes an operating system and software to operate the system. Computer may receive and process information from other components (for example, tracking subsystem, platform subsystem, and/or motion control subsystem) in order to display information to the user. Further, computer subsystem may also include a speaker to provide audio to the user.

An exemplary computer subsystem comprises one or more processors, persistent and transient memories for storing data and programs, storage access circuitry that enables the processor to read and write data and programs from and to the memories, and one or more network or other communications interface(s) (e.g., an Ethernet, 802.11, cellular radio transceiver, and direct hardware interface operably connected to external databases comprising training datasets and trained model databases). An exemplary computer system further comprises, in at least one of its persistent memories, one or more programs, which may include specialized programs to implement collected dataset processing as described herein.

By way of example, the device may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the device(s) may include a plurality of different types of movement detection sensors and combine their outputs in order to provide motion information. For example, the device(s) may use a combination of a multi-axis accelerometer and orientation sensors to provide the ability to compute positions in two-dimensional (2D) and/or three-dimensional (3D) coordinate systems.

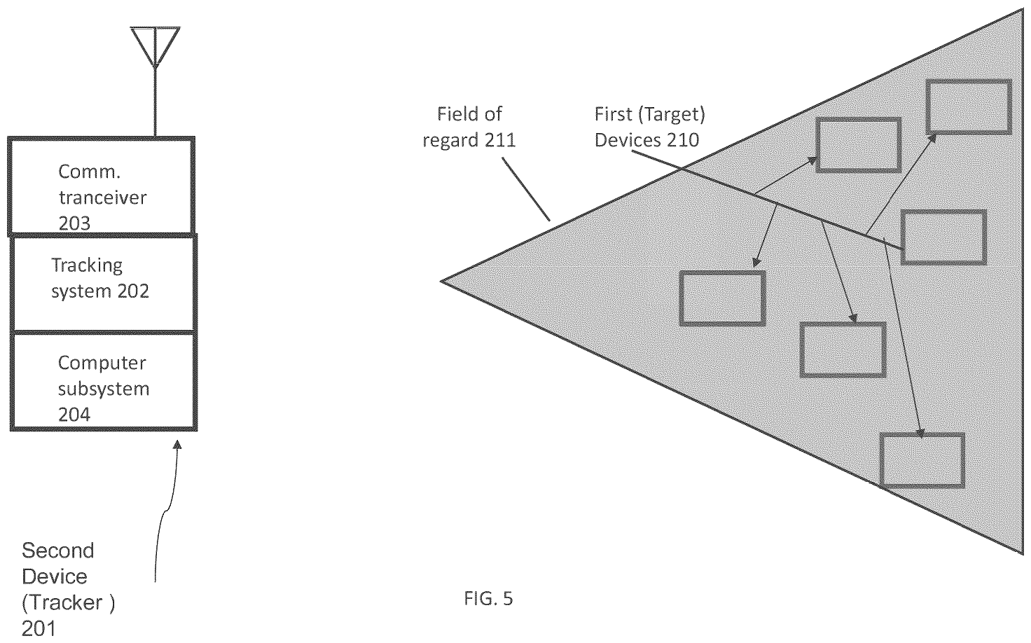

As shown in FIG. 5, an embodiment of the invention comprises a second device (Tracker) 201 comprising a tracking system 202 and receiver 203 that obtains signals from a plurality of target devices (first devices, six shown) 210 in a field of regard 211. The second device 202 generates a list of locations for each first device 210. The field of regard is the total area that a tracking system can perceive. The second device tracks the movements of all targets and stores the position of each target in a list using, for example, a computer subsystem 204. The tracking device can be calibrated to track any number of targets. FIG. 5 shows six targets for convenience, but the only limitation on the number of targets is the storage capacity of the tracker. Tracking can also be updated on a scheduled basis. For example, a tracker may track targets every 16 milliseconds and may store the 10 most recent positions of the target. The tracker, using the computer subsystem can compute the velocity and acceleration of each detected position of a target 210 based on the previous positions of the target using any convenient methods known in the art.

At various points, the tracker transmits a message, using the communications transceiver 203, to each target one-at-a-time, requesting each target to transmit its most-recent of accelerometer readings. After the tracker has received the list of accelerometer readings from all of the targets, the computer subsystem then compares each target's list of accelerometer readings to each of the lists of positions, velocities, and accelerations that the tracker recorded and/or calculated for each target.

The computer subsystem may rank the correlation of each target's accelerometer data list to each of the tracks in the track list and correlate each set of accelerometer readings from each target portion with each set of acceleration/velocity/position computations from the list of target locations stored in the track list. At that point, each track stored in the track list has an associated unique identifier provided by each target, and the system has a completed association list: that is, for every track in the track list there is an associated unique identifier. This process can be completed one time or in a round-robin manner continuously to handle the case where target portions come into and out of the field of regard 111 at a rate that is appropriate for the use case.

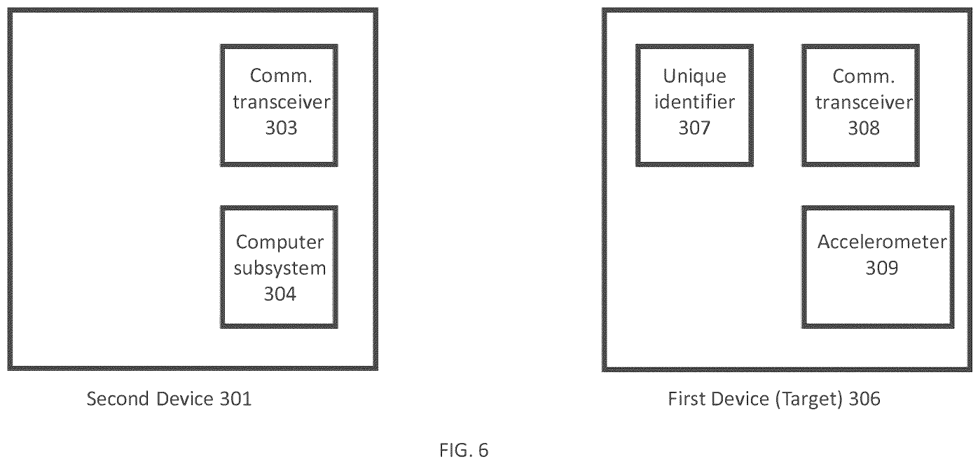

FIG. 6 shows a second device 301 comprising a communications transceiver 303. The second device may optionally comprise a computer subsystem 304 for executing commands and for communicating with the world outside the present invention. The first device or target 306 comprises a unique identifier 307, a transceiver 308, and an accelerometer 309 (which may be a single-axis, dual-axis, or three-axis accelerometer, and/or may also optionally include one or more orientation sensors).

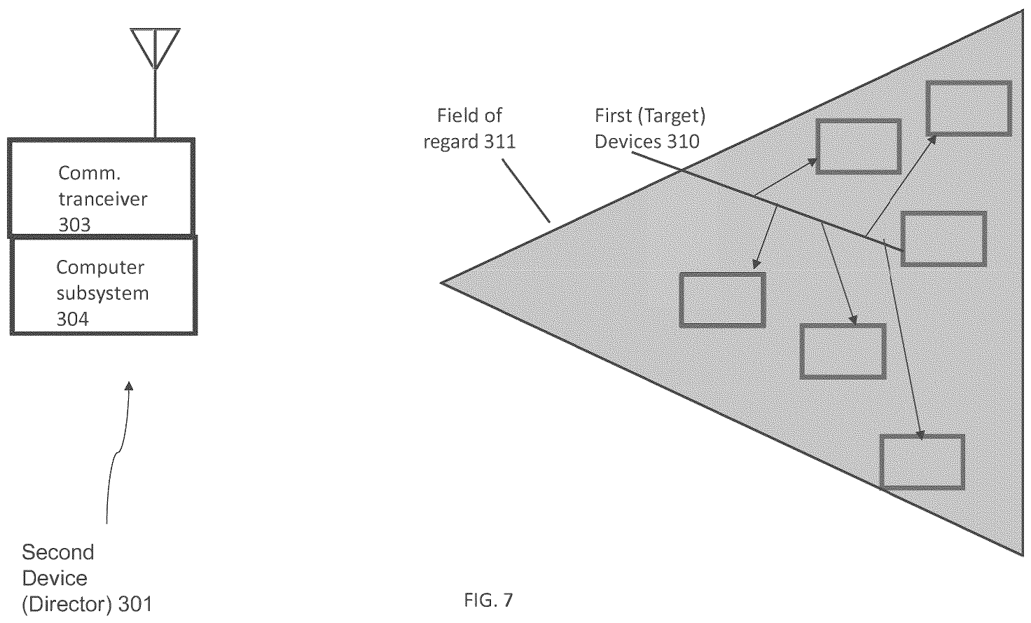

As shown in FIG. 7, an embodiment of the invention comprises a second device (e.g. a Director) 301 comprising a computer subsystem 304 and a communications transceiver 303 that communicates with a plurality of target devices (first devices, six shown) 310 in a field of regard 311. The second device (e.g. the Director) may optionally also be able to communicate with the world outside the present invention. FIG. 7 shows six targets for convenience, but the only limitation on the number of targets is the storage capacity of the Director.

In an exemplary mode of operation of a system of the invention, a first device or target first enters the Active area, and the target is caused to activate or “turn on”. At that point, the target emits an RF signal that tells the Director its unique identifier code. The Director sends back an acknowledgement RF signal to the target to give it instructions regarding what pattern the target needs to follow, in order to successfully complete a “mission”. The target immediately begins tracking its own movement through space, using the accelerometer. Note that the target may track its own x-position, y-position, z-position, azimuth angle, elevation angle, in addition to any other position or orientation measurements, or any combination thereof. The target's computer subsystem compares its list of most recent position and/or orientation measurements to the pattern that it received from the Director. When there is a close match, the target sends out a “completed” signal to the Director, and also sends out the target's unique identifier code. When the Director receives this completed-signal and identifier, it knows which target completed the mission, and the Director can then send out instructions to the target and/or the outside world e.g., lighting an LED on the target, or raising a flag.

The above process can be repeated with multiple targets in the active area. The Director can receive signals from any and all targets that successfully complete the pattern, and then the Director may choose which, if any, of the targets get sent an instruction to perform an action. The Director may also choose which if any of the targets gets mentioned in its instructions that are sent to the outside world.

For this current embodiment, an external tracking system is no longer required. Each target may provide its own tracking, and send out a “completed” signal when it successfully follows a prescribed pattern.

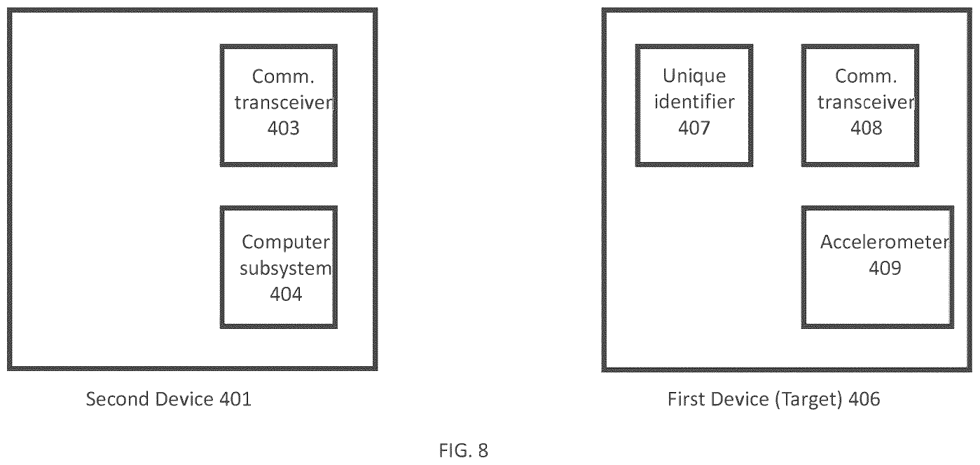

FIG. 8 shows a second device 401 comprising a communications transceiver 403. The second device may optionally comprise a computer subsystem 404 for executing commands and for communicating with the world outside the present invention. The first device or target 406 comprises a unique identifier 407, a transceiver 408, and an accelerometer 409, which may be a single-axis, dual-axis, or three-axis accelerometer, and/or may also optionally include one or more orientation sensors.

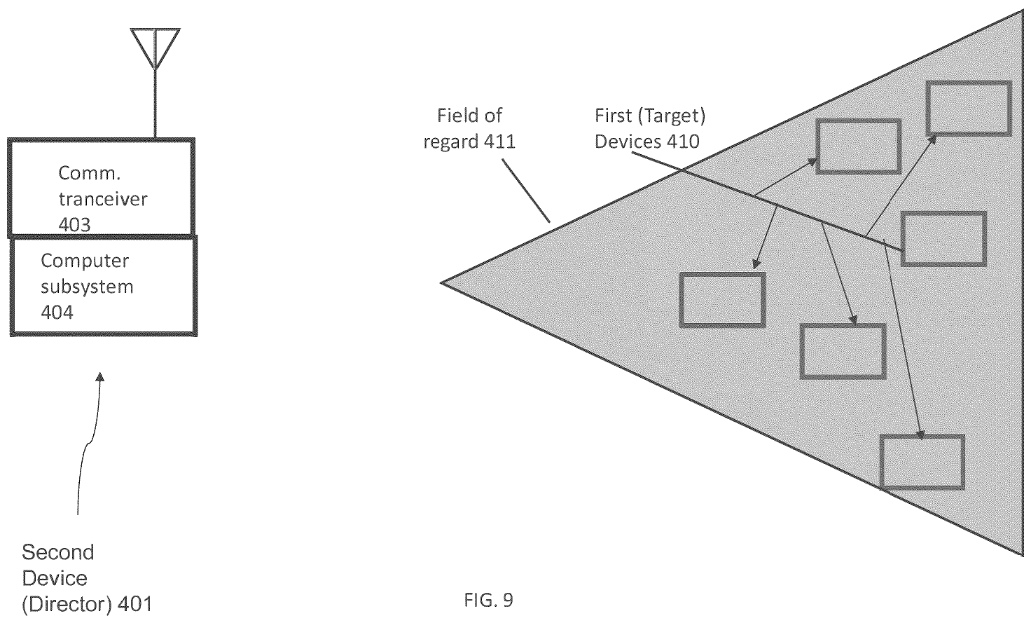

As shown in FIG. 9, an embodiment of the invention comprises a second device (e.g. a Director) 401 comprising a computer subsystem 404 and a communications transceiver 403 that communicates with a plurality of target devices (first devices, six shown) 410 in a field of regard 411. The second device (Director) may optionally also be able to communicate with the world outside the present invention. FIG. 9 shows six targets for convenience, but the only limitation on the number of targets is the storage capacity of the Director.

In an exemplary mode of operation of a system of the invention, a first device or target first enters the Active area, and the target is caused to activate or “turn on”. At that point, the target emits an RF signal that tells the Director its unique identifier code. The Director sends back an acknowledgement RF signal to the target to let the target know that the Director is now “listening” to the target's transmitted position coordinates. The target immediately begins tracking its own movement through space, using the accelerometer. At every defined interval of time (for example, 20 milliseconds) the target transmits its position/orientation coordinates using its comm transceiver. Note that the target may transmit its own x-position, y-position, z-position, azimuth angle, elevation angle, in addition to any other position or orientation measurements, or any combination thereof. Along with its position/orientation measurements the target must also transmit its unique identifier code. The Director tracks these position/orientation values and can compare them to a preset track pattern, using the Director's computer subsystem. When the Director calculates that the target has successfully followed the preset track pattern, the Director can then send out instructions to the target and/or the outside world e.g., lighting an LED on the target, or raising a flag.

The above process can be repeated with multiple targets in the active area. The Director can receive signals from any and all targets that are within the Active Area, and then the Director may choose which (if any) of the targets get sent an instruction to perform an action. The Director may also choose which if any of the targets gets mentioned in its instructions that are sent to the outside world.

For this current embodiment, an external tracking system is no longer required. Each target may provide its own tracking, and send out a “completed” signal when it successfully follows a prescribed pattern.

What is claimed is:

1. A system for remote communication, the system comprising
a first device comprising a radio frequency circuit capable of communication at a first radio frequency and a receiver circuit capable of communication at a second radio frequency;
a second device in communication with the first device over the first radio frequency; and
a stationary transmitter in communication with the first device over the second radio frequency, such that the first device is operational only when in proximity to the stationary transmitter.

2. The system of claim 1, wherein the receiver circuit is an AM receiver.

3. The system of claim 1, wherein the separate receiver broadcasts in a range from about 10 feet to about 100 feet.

4. The system of claim 1, wherein the first device comprises a battery power supply.

5. The system of claim 1, wherein the first frequency and second frequencies are non-overlapping.

6. The system of claim 1, wherein the first frequency is about 915 MHz and the second frequency is about 868 MHz.

7. A system for tracking a plurality of objects, the system comprising:
a first device comprising a communications receiver and a tracking system;
a plurality of second devices that communicate with the first device when the second devices are present in a field of regard;
wherein the first device tracks movement of the plurality of second devices independent from one another.

8. The system of claim 7, wherein the first device further comprises a computer subsystem.

9. The system of claim 8, wherein the computer subsystem keeps a track list of positions of a plurality of the second devices over time.

10. The system of claim 7, wherein each of the plurality of second devices comprises a unique identifier.

11. The system of claim 7, wherein each of the plurality of second devices comprises an accelerometer.

12. The system of claim 9, wherein the track list is stored in transient memory on the computer subsystem.
